(19) United States
(12) Patent Application Publication
(10) Pub. No.: US 2002/0117525 A1
(43) Pub. Date: Aug. 29, 2002

(54) Trailer hitch carrier

(76) Inventor: Dennis Ahola, Otisville, MI (US)

Correspondence Address: Gifford, Krass, Groh, Sprinkle,, Anderson & Citkowski, P.C., Suite 400, 280 N. Old Woodward Avenue, Birmingham, MI, 48009-5394, US

(21) Appl. No.: 10/080,342

(22) Filed: Feb. 21, 2002

Related U.S. Application Data
(60) Provisional application No. 60/270,461, filed on Feb. 21, 2001.

(51) Int. Cl. B60R 9/00; B60R 11/00

(52) U.S. Cl. 224/519; 224/518

(57) ABSTRACT

A tow hitch mounted carrier includes a pair of tubular members each having an arm and a receiver. The receiver of each tubular member engages a transverse aperture in the tow hitch. Each member arm extends outward from the hitch at an angle between 60° and 120°. A platform secures to the arms of the pair of tubular members. A process for coupling a carrier to a vehicle includes the insert of a pair of tubular members each having arms into tow hitch transverse apertures in opposition and securing a platform to the tubular members.

This application claims priority of U.S. Provisional Pat. App. Ser. No. 60/270,461 filed Feb. 21, 2001 and is incorporated herein by reference.

### FIELD OF THE INVENTION

The present invention relates generally to a vehicle attachment and, more particularly, to a removable, hitch mounted vehicle carrier.

### BACKGROUND OF THE INVENTION

Drivers often have a need to transport articles that are inconvenient to load within the passenger compartment, or bed of a vehicle. Articles such as all-terrain vehicles, snowmobiles, animal carcasses, and firewood are representative of such articles. The transport of such articles has heretofore required the use of a hitch mounted platform or, alternatively, the pulling of a trailer. The pulling of a trailer to transport an article has several limitations including reducing the handling characteristics of the vehicle, reducing the fuel efficiency of the vehicle, and storage of the trailer when not in use. Trailers are frequently required to transport loads of greater than a few hundred pounds owing to the limitations of prior art hitch mounted platforms.

The torque and flexing of a hitch platform mount associated with the load of an article on a moving vehicle creates an engineering challenge in the art. As a result of torque associated with single point hitch mounts, the weight distribution and load capacity of this type of hitch mounted platform are severely limited. Representatives of single point hitch mounted platforms are shown in U.S. Pat. Nos. 5,996,869; 5,372,287; 5,106,002; 3,650,443; and 3,913,811. The flex of a hitch mounted platform also presents a safety concern as a flexing platform or otherwise downward bent platform may abruptly strike the road surface, especially an inclined road surface, thereby causing an unexpected drag on the vehicle. Prior art attempts to limit platform flex have included two point platform mount assemblies that elevate relative to the hitch plane. Representative two point hitch mounts include those shown in U.S. Pat. Nos, 4,915,276; 5,439,151; and 5,224,636. The complex assemblies associated with these two point hitch mounts are limited in usefulness owing to joint stresses and still suffer considerable flex. Thus, there exists a need for a hitch mounted attachment capable of withstanding greater torque and flex than existing devices.

### SUMMARY OF THE INVENTION

A tow hitch mounted carrier includes a pair of tubular members each having an arm and a receiver. The receiver of each tubular member engages a transverse aperture in the tow hitch. Each member arm extends outward from the hitch at an angle between 60° and 120° . A platform secures to the arms of the pair of tubular members.

A process for coupling a carrier to a vehicle includes the insert of a pair of tubular members each having arms into tow hitch transverse apertures in opposition and securing a platform to the tubular members.

### BRIEF DESCRIPTION OF THE DRAWINGS

FIG. 1 is an exploded view of an embodiment of the inventive hitch carrier; and

FIG. 2 is an elevated perspective view of the carrier shown in FIG. 1 coupled to a vehicle.

### DETAILED DESCRIPTION OF THE PREFERRED EMBODIMENTS

The present invention has utility as a vehicle carrier or as an attachment assembly for a variety of vehicle accessories by way of a transverse tow hitch. The present invention affords the ability to carry heavier loads in greater safety as compared to conventional hitch carriers.

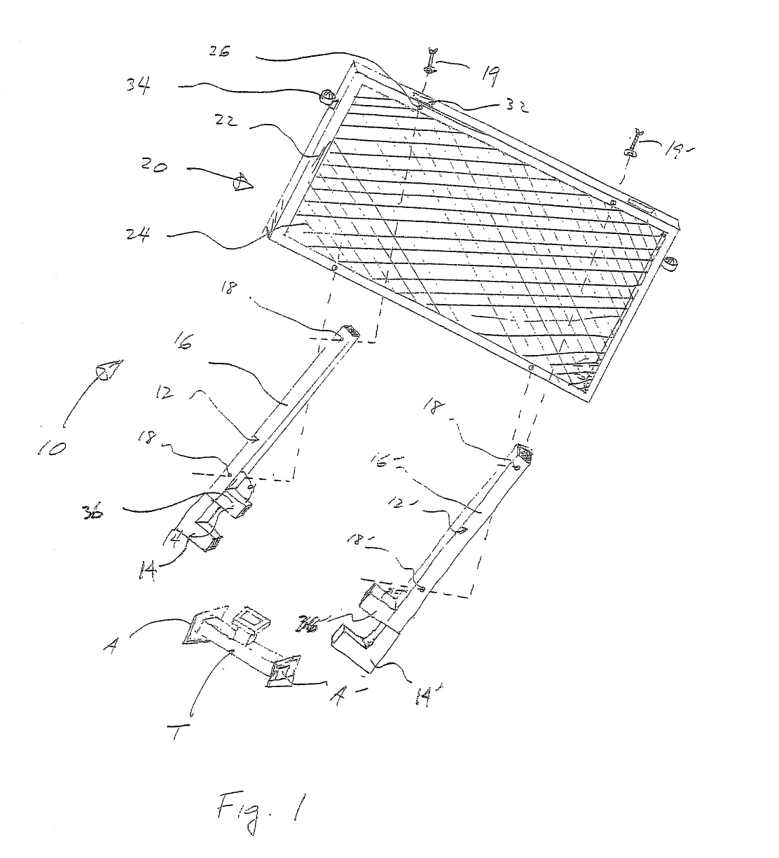

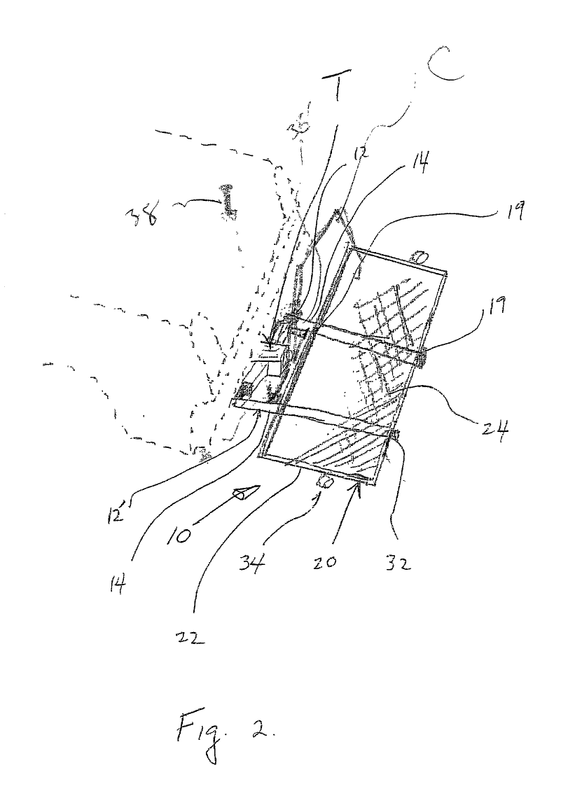

A carrier according to the present invention is shown generally at 10 in FIGS. 1 and 2. A pair of tubular members 12 and 12′ are provided to engage a conventional three point tow hitch T, and to support a carrier load (not shown). The tubular member 12 has a receiver portion 14 adapted to be received within a transverse aperture A of the tow hitch T. The receiver portion 14 is preferably formed of square cross section tube stock. Three inch tubular steel stock is an exemplary material from which a receiver 14 is crafted. It is appreciated that the receiver portion is readily fashioned from other materials illustratively including steel, aluminum, titanium, and graphite composite materials. The receiver 14 is welded or otherwise made integral, depending on the receiver material, with an arm 16 extending from the receiver 14 at an angle α. The angle a is between about 60° and about 120°. In a preferred embodiment, the angle a is about 90°. As with the receiver 14, the arm portion 16 is formed of solid or tubular materials illustratively including steel, aluminum, and graphite composites; it is preferred that the arm portion 14 be formed from tubular steel stock. Tubular steel stock having a dimensional cross section of two inches by three inches is particularly well suited for use in the present invention. The arm portion 14 has an aperture 18 therethrough adapted to receive a fastener 19 for securing the first tubular member 12 to the second tubular member 12′ thereby retaining the receivers 14 and 14′ within the tow hitch apertures A and A′, respectively. Components of the second tubular member 12′ similar to those of the first tubular member 12 are denoted with primed like numerals.

A platform 20 includes a frame 22 bounding floor sheeting 24. The frame 22 has apertures 26 therethrough. An aperture 26 is adapted to receive a fastener 19 therethrough, the fastener 19 simultaneously engaging an aperture 18 or 18′ of a tubular member 12 or 12′, respectively. In a preferred embodiment, the fastener 19 is an Allen head bolt inserted into a tapped bolt hole of an aperture 18 or 18′. It is appreciated that a retainer such as a cotter pin or lock nut alternatively retains the fastener 19 in simultaneous secure contact with the frame 20 and the tubular member 12 or 12′. Thus, the frame 20 serves as a carrier load contacting surface as well as a lateral support for the inventive carrier. While the frame 22 and the sheeting material 24 are readily constructed from a variety of materials illustratively including steel, aluminum, wood, fiberglass, and high impact polymers, in a preferred embodiment, the frame 22 is welded steel bar and the sheeting material 24 is expanded steel, welded to the frame 22. Optionally, reflective tape 32 or lights 34 are affixed to a carrier 10 in order to enhance the visibility and therefore the operational safety of the present invention. The present invention optionally has hinge mounts (not shown) distal to the tow hitch T attached to the frame 20 or tubular members 12 and 12′. A detachable platform loading ramp is selectively secured to the inventive carrier through the use of a pin to simultaneously engage the hinge mounts and a complementary mount arrangement attached to a ramp edge portion. It is appreciated that the inventive carrier is readily combined with accessories simultaneously engaging the lateral aperture of the tow hitch T or alternatively secured to an inventive carrier through engaging optional coupling extenders 36 and 36′, into or over which an accessory C is engaged and secured with a pin 38. Accessory C illustratively includes a winch, a crane and a rigid platform cover. Optionally, the frame 22 is decorated with protective covering tie down mounts (not shown).

The foregoing description is illustrative of particular embodiments of the invention, but is not meant to be a limitation upon the practice thereof. The following claims, including all equivalents thereof, are intended to define the scope of the invention.

1. A carrier mounted to a tow hitch comprising:
a pair of tubular members each having an arm and a receiver, the receiver of each tubular member adapted to engage a transverse aperture in the tow hitch and the arm of each tubular member independently extending outward from the tow hitch at an angle between 60° and 120°; and
a platform secured to the arms of the pair of tubular members.

2. The carrier of claim 1 wherein said pair of tubular members are formed of square tubular steel.

3. The carrier of claim 1 wherein the angle is between 80° and 100°.

4. The carrier of claim 1 wherein said platform comprises a frame and sheeting material encompassed therein.

5. The carrier of claim 4 wherein the sheeting material is expanded metal.

6. The carrier of claim 1 further comprising a reflector.

7. The carrier of claim 1 further comprising a light.

8. The carrier of claim 1 further comprising hinge mounts adapted to engage a platform ramp.

9. The carrier of claim 1 further comprising tie down mounts on said platform.

10. The carrier of claim 1 further comprising in combination a tow hitch mounted accessory.

11. The carrier of claim 10 wherein the accessory is selected from the group consisting of: a winch, a crane and a rigid platform cover.

12. The carrier of claim 1 wherein said pair of unitary tubular members each has a coupling extended aligned to secure an accessory thereto.

13. The carrier of claim 12 wherein the accessory is selected from the group consisting of: a winch, a crane and a rigid platform cover.

14. The carrier of claim 1 wherein each of the pair of tubular members is unitary.

15. A process for coupling a carrier to a vehicle comprising the steps of:
inserting a receiver of a first tubular member into a transverse aperture of a tow hitch such that an arm of the tubular member extends outward from the tow hitch;
inserting a second tubular member in a second transverse aperture in the tow hitch such that the first tubular member and second tubular member are in opposition; and
securing a platform to the first tubular member and the second tubular member.

16. The process of claim 15 further comprising the step of:
coupling an accessory to the first and second tubular members through engaging a coupling extender of at least one of the first and second tubular members.

17. The process of claim 16 wherein both the first and second tubular members have coupling extenders engaging an accessory.

18. The process of claim 16 wherein the accessory is selected from the group consisting of: a winch, a crane and a rigid platform cover.

19. The process of claim 15 further comprising the step of inserting an accessory into a lateral aperture of the tow hitch.
